(19) United States
(12) Patent Application Publication
(10) Pub. No.: US 2007/0274513 A1
(43) Pub. Date: Nov. 29, 2007

(54) Method and system for estimating data rate of a local loop

(75) Inventors: Jin Wang, Walnut Creek, CA (US); Richard Dennis Hart, Concord, CA (US); Ganesh Krishnamurthi, Danville, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/417,850

(22) Filed: May 4, 2006

(51) Int. Cl. H04M 1/00; H04M 3/00

(52) U.S. Cl. 379/380

(57) ABSTRACT

A computer system comprises a memory and a processor. The memory provides an empirical model for estimating data rates of local loops having one or more bridged taps. The processor uses the empirical model to estimate and output a data rate of a local loop that includes a bridged tap. The processor estimates the data rate using the empirical model based on an equivalent working length (EWL) for the local loop, a tap length value that is based on a length of the bridged tap, and a tap location value that is based on a location of the bridged tap.

### FIELD OF THE DISCLOSURE

The present disclosure is generally related to estimating a data rate of a local loop.

### BACKGROUND

Digital subscriber line (DSL) technology provides transport of high-bit-rate digital information over telephone subscriber lines. Examples of various types of DSL include asymmetric DSL (ADSL), high-bit-rate DSL (HDSL), HDSL2 , single-line HDSL (SHDSL) and very-high-bit rate DSL (VDSL). The different types of DSL are differentiated by operating frequency, power spectrum and communication format.

ADSL is capable of simultaneously transporting downstream (toward a customer) bit rates of up to 8 Mbps, upstream (toward a network) bit rates of up to 1 Mbps, and plain-old telephone service (e.g. analog voice) via one pair of telephone wires.

VDSL is an extension of ADSL to a higher downstream rate (e.g. of up to 52 Mbps). At such high bit rates, short loops are desired so that an optical fiber is used for all but the last thousand feet to the customer. While some DSLs are intended for use from a central office (CO) to a customer premise, VDSL is primarily used for loops fed from an optical network unit (ONU) usually co-located with a serving area interface (SAI) such as a crossbox. In a telephone network, the SAI is a demarcation point where a feeder cable of roughly 1000 wire pairs is broken into multiple distribution cables of roughly 100 wire pairs to serve widely-spread customers.

Referring to FIG. 1, a VDSL line comprises a VDSL transmission unit at an optical side (VTU-O) 10, a local loop 12 from the ONU to a customer premise, and a VDSL transmission unit at a remote side (VTO-R) 14. The local loop 12 may comprise a twisted pair, for example. For downstream transmissions, source data 16 is communicated from the VTU-O 10 to the VTU-R 14 via the local loop 12 to provide recovered source data 20 at the customer premise. For upstream transmissions, source data is communicated from the VTU-R 14 to the VTU-O 10 via the local loop 12 to provide recovered source data at a network end.

VDSL can support voice, data and video applications simultaneously. A high-definition television (HDTV) video stream may require a bit pipe of 7 Mbps. To simultaneously provide voice, data, and two or more HDTV channels to a customer, a VDSL rate of about 20 Mbps (or another threshold) downstream may be required. If an actual VDSL rate falls short of the threshold, the customer may not receive a desired service.

VDSL service providers are interested in predicting a VDSL rate for a local loop before deploying VDSL to a customer. The topic of DSL rate estimation has been addressed in U.S. Pat. No. 6,633,545 and Starr et al., Understanding DSL Technology, 1997, Prentice Hall PTR, Upper Saddle River, N.J.

Existing methods to estimate a VDSL rate on a local loop comprise measuring loop parameters including a loop insertion loss, background noise on a telephone pair at a VTU-O location, and background noise on a telephone pair at a VTU-R location. The loop insertion loss is an attenuation of a signal from either the VTU-O to the VTU-R or in a reverse direction. The background noise is caused by amplitude modulation (AM) radio transmissions, ham radio transmissions, aeronautical mobile transmissions and electromagnetic activities at the customer premise. The background noise of the telephone pair at the VTU-O location is used for upstream rate estimation. The background noise of the telephone pair at the VTU-R location is used for downstream rate estimation.

Both loop insertion loss and background noise are frequency dependent. Since each parameter is a function of frequency or a curve that varies with frequency, the loop insertion loss may be referred to as a loss curve and the background noise may be referred to as a noise spectrum.

The loop insertion loss and background noise are determined by conducting a double-ended loop measurement. To conduct a double-ended loop measurement, two technicians are dispatched to the field: one technician at the SAI and another technician at the customer side. Deploying technicians to perform double-ended loop measurements for all customer loops (e.g. which may number in the millions and be widely spread out), in order to qualify or disqualify the loops for VDSL service, can be costly and time consuming if not otherwise impractical.

In addition to the above loop parameters, modem parameters are also used for VDSL rate estimation. The modem parameters include a transmitting power of the VTU-O and VTU-R, and internal circuit noise of the VTU-O and VTU-R. The internal circuit noise of the VTU-O or VTU-R is also called modem front-end noise as it is generated mainly from a modem's front-end circuits. The transmission power is specified in a VDSL standard.

Existing DSL rate estimation methods behave undesirably in the presence of one or more bridged taps. A bridged tap is a segment of open-ended twisted pair which branches off from a signal path. Bridged taps are often located at a customer end of the network near the VTU-R. A bridged tap impacts signal transmission by introducing extra loop insertion loss by reflecting and absorbing a signal and impedance mismatch by changing an impedance of a telephone pair. The impedance mismatch is not captured in an insertion loss measurement.

### BRIEF DESCRIPTION OF THE DRAWINGS

FIG. 1 (prior art) is a block diagram of a DSL line;

FIG. 2 is a flow chart of an embodiment of a method of estimating a DSL rate of a loop;

FIG. 3 is a chart showing loss curves for a loop with and without a bridged tap;

FIG. 4 is an example of two tables in an empirical model for estimating loop EWL in the presence of a bridged tap;

FIG. 5 is chart of field and laboratory VDSL rate reach curves for estimating a VDSL rate in the absence of a bridged tap;

FIG. 6 is a chart of modem front-end noise, background noise and VDSL crosstalk versus frequency; and

FIG. 7 is a block diagram of an illustrative embodiment of a general computer system.

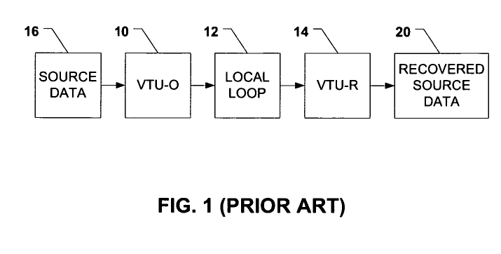

### DETAILED DESCRIPTION OF THE DRAWINGS

Disclosed herein are embodiments of an improved and less-costly method of prequalifying telephone loops for VDSL service which obviates a double-ended loop measurement. The loop insertion loss is parameterized by one quantity, namely equivalent working length (EWL), which can be obtained without a double-ended loop measurement. Measurement of the background noise on the VDSL loop is obviated because its impact on the VDSL rate is shown to be insignificant. To account for impedance mismatch introduced by a bridged tap, empirical data is used to accurately estimate a VDSL rate in the presence of the bridged tap. A corresponding table of empirical data is provided for each of a plurality of different loop EWL values. Each table stores a corresponding empirically-measured VDSL rate for each of a plurality of different combinations of a tap-distance-to-CPE value and a tap length value. Thus, the VDSL rate for a loop can be determined by referring to one or more appropriate tables based on the EWL value for the loop, using the one or more appropriate tables to perform one or more lookup operations based on the tap distance and tap length of the loop, and estimating the VDSL rate for the loop based on one or more values retrieved from the one or more lookup operations.

For purposes of illustration and example, embodiments are described for estimating a data rate for VDSL. Those having ordinary skill will recognize that the embodiments also apply to estimating alternative data rates for alternative types of digital communications (e.g. alternative DSL communications) and alternative communication channels.

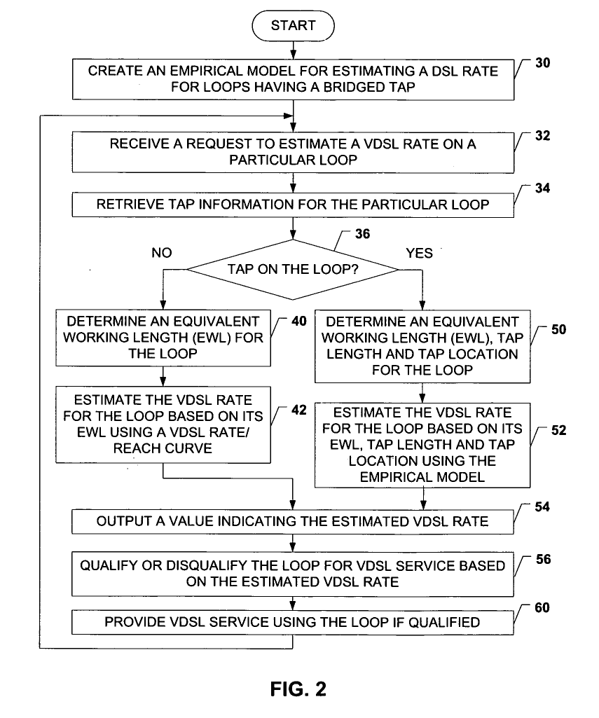

FIG. 2 is a flow chart of an embodiment of a method of estimating a DSL rate of a loop. As indicated by block 30, the method comprises creating a first empirical model that estimates DSL rates for loops having one or more bridged taps. The first empirical model is stored in a memory of a computer system.

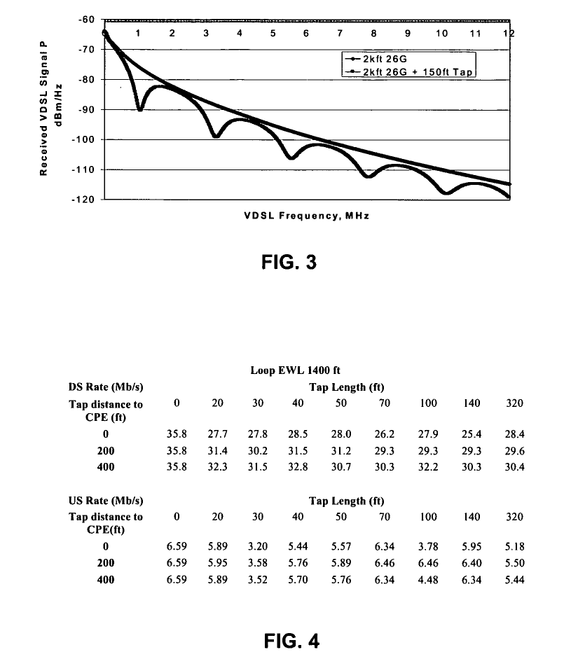

A bridged tap, by absorbing and reflecting signals in the loop, causes an excessive loss which leads to a reduced VDSL rate. For example, the VDSL rate may be reduced by 20% because of the presence of a bridged tap. Further, in the presence of a bridged tap, a loop loss curve may exhibit a series of notches as depicted in FIG. 3. A bridged tap also causes impedance mismatch between a VDSL modem and the telephone loop, which disrupts the function of the modem front-end. This effect is more pronounced when the bridged tap is near the VTU-O or the VTU-R. For example, the VDSL rate may be reduced by 30% because of impedance mismatch if the tap is near the VTU-R.

The first empirical model accounts for the bridged tap by providing an estimated VDSL rate for a loop based on its EWL, its tap distance to customer premises equipment (CPE) and its tap length. Preferably, the first empirical model is based on empirical rate results measured in a laboratory. In an embodiment, the first empirical model comprises a plurality of tables each associated with a corresponding one of a plurality of different EWLs. To generate a table for a particular EWL, typical VDSL equipment is coupled to a loop having the particular EWL and having a bridged tap, and a respective VDSL rate is measured for each of a plurality of different tap distances and a plurality of different tap lengths. This process is repeated for different loops having the different EWLs.

FIG. 4 shows an example of two tables in the first empirical model. The two tables are generated for a loop having an EWL of 1400 ft with one bridged tap. A first table shows measured downstream rate values as a function of tap length and tap distance values. A second table shows measured upstream rate values as a function of tap length and tap distance values. The rate values were measured for tap length values of 0 ft, 20 ft, 30 ft, 40 ft, 50 ft, 70 ft, 100 ft, 140 ft and 320 ft, and for tap distance values of 0 ft, 200 ft and 400 ft. Those having ordinary skill will recognize that either more or fewer tap length values and/or distance values may be used in the model, and that different tap length values and/or tap distance values may be used in the model.

Referring back to FIG. 2, as indicated by block 32, the method comprises receiving a request to estimate a VDSL rate on a particular loop. As indicated by block 34, the method comprises retrieving tap information for the particular loop. The tap information indicates whether or not a bridged tap is present on the particular loop. The tap information may be retrieved from a database. As indicated by block 36, the method comprises determining whether or not a bridged tap exists in the particular loop based on the tap information.

If the particular loop is absent any bridged taps, the method comprises determining a loop-equivalent EWL for the particular loop (as indicated by block 40). The loop-equivalent EWL is often defined in various different ways for different embodiments. In an embodiment, the loop-equivalent EWL is defined as a length of 26-gauge Cat-3, PIC cable at 70° F. that has the same insertion loss at 500 kHz as the original loop.

Use of EWL is proposed to take into account gauge mix in telephone networks. For example, many local loops comprise not only 26-gauge cable, but also 24-gauge, 22-gauge and 19-gauge cables. A 1 kft 24-gauge cable has less loss than a 1 kft 26-gauge cable, but has the same loss as 0.8 kft 26-gauge cable at 500 kHz. Thus, the 1 kft 24-gauge cable has an EWL of 0.8 kft. By using EWL as a loop length for VDSL, the VDSL rate can be estimated based on the EWL independently of gauge mix.

The loop EWL can be determined using various methods. Three examples of methods of determining the loop EWL are as follows.

In a first method, the loop EWL is extracted from loop loss data acquired through a double-ended loss measurement. For example, if a measured loss on a cable at 500 kHz is 11 dB, and it is known that the loss of 1 kft 26-gauge Cat-3, PIC cable at 70° F. is 5.5 dB, then the loop EWL is 1 kft* 11 db/5.5db=2 kft. Thus, the EWL is determined by dividing the measured loss by the known loss of a known length of cable, and multiplying this quotient by the known length. Though double-ended loss measurement is required in this method, the measurement need not conducted on every pair to obtain its EWL. A loss measurement can be conducted for only one pair of multiple pairs dropped to the same terminal to determine its EWL, and the same EWL can be assigned to all of the pairs dropped to the same terminal. In terminals serving multiple-dwelling units that have 100 pairs dropped, for example, this method saves 99% of double-ended measurements.

In a second method, the loop EWL is calculated from loop makeup information in the loop record. The loop makeup information can be stored in a database. For example, consider a loop that is known to be made up of two segments: a 26-gauge PIC cable having a physical length of 1 kft and a 24-gauge PIC cable having a physical length of 2 kft. The loop EWL can be calculated as a sum of the EWLs for each segment, where the EWL for each segment is equal to its physical length times a loss ratio of its gauge cable to 26-gauge cable. Thus, in the above example, the loop EWL is calculated as the sum of 1 kft*1 (for the 26-gauge PIC cable) and 2 kft*0.8 (for the 24-gauge PIC cable), which equals 2.6 kft.

In a third method, the loop EWL is estimated using loop capacitive length and gauge-mix information. Loop capacitive length can be measured through a single-ended measurement at an SAI using a capacitance meter. However, loop capacitive length does not include information on gauge mix. For example, a 1 kft 24-gauge cable has the same loop capacitive length as a 1 kft 26-gauge cable. Thus, to estimate the loop EWL, the measured loop capacitive length is multiplied by a conversion factor based on the gauge-mix information.

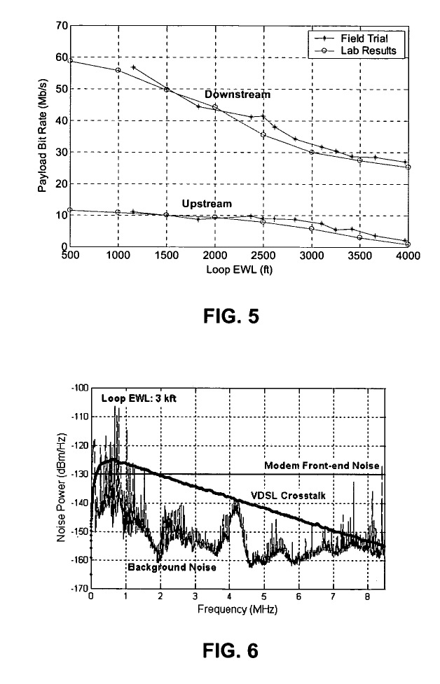

As indicated by block 42, the method comprises estimating the VDSL rate based on the loop EWL. This act may comprise using a second empirical model that relates the loop EWL to the VDSL rate. The second empirical model may provide a downstream reach curve and/or an upstream reach curve obtained either in the field or laboratory. Examples of field and laboratory reach curves stored in the second empirical model are shown in FIG. 5. Because the field and laboratory reach curve are close to each other, either one or both can be used to estimate the VDSL rate. Interpolation or curve fitting can be used to estimate the VDSL rate for any loop EWL value.

The curves in FIG. 5 show that the VDSL rate reach curves recorded in the lab and field are similar even though background noise for laboratory loops differ from background noise for field loops. As shown in FIG. 6, background noise does not significantly impact the VDSL rate because of its practical insignificance compared to modem front-end noise in either the VTU-O or the VTU-R. In particular, FIG. 6 shows three main components of noise in a VDSL receiver: background noise on a telephone pair, crosstalk noise from neighboring DSL circuits, and modem front-end circuit noise. The modem front-end noise of VTU-O or VTU-R can be measured in a lab environment where all other noise is substantially absent. The crosstalk noise from neighboring DSL circuits or modem front-end noise typically is higher than the background noise. Thus, the loop background noise need not be measured to estimate the VDSL rate.

Referring back to block 36 in FIG. 2, if a bridged tap is present on the particular loop, then a different process is used to estimate the VDSL rate. As indicated by block 50, the method comprises retrieving a loop EWL, a tap length and a tap location for the particular loop if a bridged tap is present. The loop EWL can be looked up from a database or determined using any of the methods described with reference to block 40. The tap length and tap location can be retrieved from a loop record or determined using a field measurement. An example of a field measurement is a time-domain reflectometry (TDR) measurement, which is a single-ended loop measurement that can be conducted at the SAI or customer premises equipment (CPE) side. Thus, either no field measurement or a single-ended loop measurement, in contrast to a double-ended loop measurement, is performed to estimate the VDSL rate.

As indicated by block 52, the method comprises estimating the VDSL rate for the particular loop using the first empirical model based on the loop EWL, the tap length and the tap location. In an embodiment, one or more lookup operations of one or more tables whose loop EWL are closest to the loop EWL of the particular loop is performed. One or more measured values of the VDSL rate are looked up from these one or more tables based on the tap length and the tap location. Interpolation and/or curve fitting can be used to estimate the VDSL rate for a loop EWL value that is between two EWL values in the tables, for a tap length value that is between two tap length values in the tables, and for a tap location value that is between two tap location values in the tables. Thus, two or more measured VDSL rates that are retrieved based on the lookup operations can be interpolated or curve-fitted to produce an estimated VDSL rate value.

It is noted that if the loop makeup is not known in block 50, a double-ended measurement may be performed to estimate the VDSL rate for the loop.

As indicated by block 54, the method comprises outputting a value indicating the estimated VDSL rate, whether the rate is estimated in block 42 or block 52. If the estimated VDSL rate value is determined by a processor of a computer system, the processor can output the value to a memory, to a display device, to a printer, or to a peripheral device, for example.

As indicated by block 56, the method comprises qualifying or disqualifying the particular loop for VDSL service based on the estimated VDSL rate. If the estimated VDSL rate is at or above a threshold, the loop may be qualified for VDSL service. If the estimated VDSL rate is below the threshold, the loop may be disqualified for the VDSL service.

Optionally, as indicated by block 60, the method comprises providing VDSL service to a customer premise using the loop if the loop has been qualified in block 56. In an embodiment, the VDSL service may be provided based on a digital multi-tone (DMT) technique. DMT-VDSL divides a 0-12 MHz band into thousands of 4.3125 kHz-wide tones (also known as bins) in a frequency-division multiplex scheme.

Flow of the method is directed back to block 32 one or more times to estimate a corresponding VDSL rate for one or more other loops.

It is noted that either as an alternative or in addition to using empirical data, a dynamic term can be added to the aggregate noise in the VDSL modem to account for impedance mismatch. However, use of empirical data is preferred in the absence of a formula to estimate the strength of the dynamic term and inferring its presence from a signal-to-noise curve of modems in a diagnostic mode.

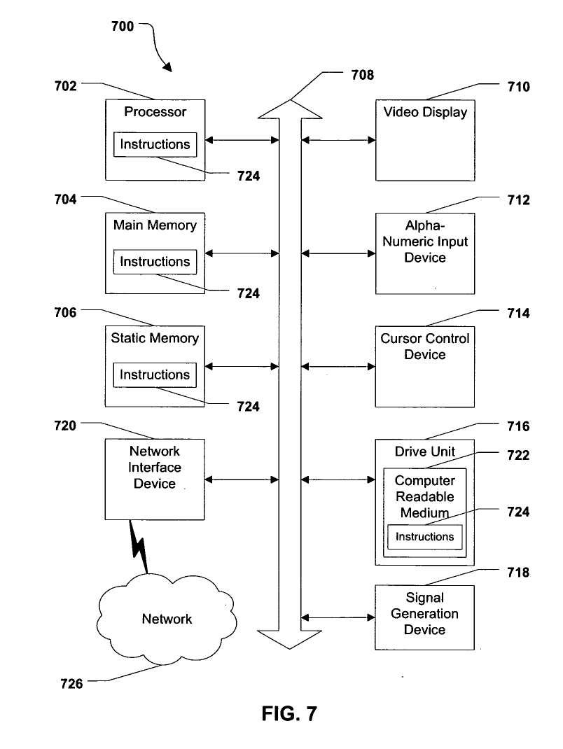

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 can include a main memory 704 and a static memory 706, that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
storing, in a memory of a computer system, an empirical model for estimating data rates of local loops having one or more bridged taps;
determining an equivalent working length (EWL) for a local loop that includes a bridged tap;
determining a tap length value based on a length of the bridged tap;
determining a tap location value based on a location of the bridged tap; and
using the empirical model stored in memory of the computer system to estimate a data rate of the local loop based on the EWL, the tap length value and the tap location value.

2. The method of claim 1 further comprising:
providing a digital subscriber line (DSL) service using the local loop.

3. The method of claim 1 further comprising:
qualifying the local loop for a digital subscriber line (DSL) service based on the data rate.

4. The method of claim 1 further comprising:
outputting a value indicating the data rate.

5. The method of claim 1 wherein the data rate comprises a very-high-bit-rate digital subscriber line (VDSL) data rate.

6. The method of claim 1 wherein the empirical model comprises a plurality of tables for a plurality of different EWL values, each of the plurality of tables being associated with a corresponding loop having a corresponding one of a plurality of different EWL values, each of the plurality of tables comprising a plurality of measured data rate values for its corresponding loop for a plurality of different tap distances and a plurality of different tap lengths.

7. The method of claim 6 wherein said using the empirical model comprises performing one or more lookup operations of one or more of the tables whose corresponding EWL value is closest to the EWL of the local loop, and wherein the one or more lookup operations retrieve one or more measured data rate values from the one or more tables based on the tap length value and the tap location value.

8. The method of claim 6 wherein said using the empirical model comprises performing two or more lookup operations of one or more of the tables to retrieve two or more measured data rate values based on the EWL, the tap length value and the tap location value.

9. The method of claim 8 wherein said using the empirical model comprises interpolating the two or more measured data rate values to estimate the data rate.

10. The method of claim 8 wherein said using the empirical model comprises curve fitting the two or more measured data rate values to estimate the data rate.

11. The method of claim 1 wherein the tap location value is based on a distance from the bridged tap to a customer premises equipment (CPE).

12. A computer-readable medium having computer-readable program code to cause a computer system to perform acts of:
providing an empirical model for estimating data rates of local loops having one or more bridged taps; and
using the empirical model to estimate a data rate of a local loop that includes a bridged tap, the data rate being estimated using the empirical model based on an equivalent working length (EWL) for the local loop, a tap length value that is based on a length of the bridged tap, and a tap location value that is based on a location of the bridged tap.

13. The computer-readable medium of claim 12 wherein the acts further comprise:
outputting a value indicating the data rate.

14. The computer-readable medium of claim 12 wherein the data rate comprises a very-high-bit-rate digital subscriber line (VDSL) data rate.

15. The computer-readable medium of claim 12 wherein the empirical model comprises a plurality of tables for a plurality of different EWL values, each of the plurality of tables being associated with a corresponding loop having a corresponding one of a plurality of different EWL values, each of the plurality of tables comprising a plurality of measured data rate values for its corresponding loop for a plurality of different tap distances and a plurality of different tap lengths.

16. The computer-readable medium of claim 15 wherein said using the empirical model comprises performing one or more lookup operations of one or more of the tables whose corresponding EWL value is closest to the EWL of the local loop, and wherein the one or more lookup operations retrieve one or more measured data rate values from the one or more tables based on the tap length value and the tap location value.

17. The computer-readable medium of claim 15 wherein said using the empirical model comprises performing two or more lookup operations of one or more of the tables to retrieve two or more measured data rate values based on the EWL, the tap length value and the tap location value.

18. The computer-readable medium of claim 17 wherein said using the empirical model comprises interpolating the two or more measured data rate values to estimate the data rate.

19. The computer-readable medium of claim 17 wherein said using the empirical model comprise curve fitting the two or more measured data rate values to estimate the data rate.

20. The computer-readable medium of claim 12 wherein the tap location value is based on a distance from the bridged tap to a customer premises equipment (CPE).

21. A computer system comprising:
a memory to provide an empirical model for estimating data rates of local loops having one or more bridged taps; and
a processor which uses the empirical model to estimate and output a data rate of a local loop that includes a bridged tap, the processor to estimate the data rate using the empirical model based on an equivalent working length (EWL) for the local loop, a tap length value that is based on a length of the bridged tap, and a tap location value that is based on a location of the bridged tap.
